(19) United States
(12) Patent Application Publication
(10) Pub. No.: US 2019/0221824 A1
(43) Pub. Date: Jul. 18, 2019

(54) NON-AQUEOUS ELECTROLYTE SECONDARY BATTERY

(71) Applicant: Panasonic Intellectual Property Management Co., Ltd., Osaka (JP)

(72) Inventors: Tomoki Tsuji, Osaka (JP); Manabu Takijiri, Osaka (JP); Yoshinori Sakai, Hyogo (JP); Masanobu Takeuchi, Tokyo (JP)

(73) Assignee: Panasonic Intellectual Property Management Co., Ltd., Osaka (JP)

(21) Appl. No.: 16/358,920

(22) Filed: Mar. 20, 2019

Related U.S. Application Data
(63) Continuation of application No. PCT/JP2017/024621, filed on Jul. 5, 2017.

(30) Foreign Application Priority Data
Sep. 30, 2016 (JP) 2016-193283

(51) Int. Cl. H01M 2/26; H01M 10/0587; H01M 2/02; H01M 4/525; H01M 10/0525

(52) U.S. Cl. CPC H01M 2/263; H01M 10/0587; H01M 10/0525; H01M 4/525; H01M 2/022

(57) ABSTRACT

This non-aqueous electrolyte secondary battery has an electrode body comprising a positive electrode and a negative electrode which are wound around while sandwiching a separator therebetween, and housed in a cylindrical housing member. The positive electrode has a positive electrode collector and a positive electrode active substance layer extending above the positive electrode collector. The negative electrode has a negative electrode collector, a negative electrode active substance layer extending above the negative electrode collector, and a negative electrode lead connected to the negative electrode collector. The negative electrode lead is disposed more toward the wound core of the electrode body than the end portion of the negative electrode active substance layer and the end portion of the positive electrode active substance layer.

### TECHNICAL FIELD

The present disclosure relates to a non-aqueous electrolyte secondary battery.

### BACKGROUND ART

As a non-aqueous electrolyte secondary battery, there is the one described in Patent Literature 1. In the non-aqueous electrolyte secondary battery, a long positive electrode and a long negative electrode are spirally wound with a separator sandwiched between the long positive electrode and the long negative electrode. The positive electrode of the non-aqueous electrolyte secondary battery has a both-side region where positive electrode active substrate layers are provided on both surfaces of the positive electrode collector, and a one-side region where a positive electrode active substance layer is provided on only one side. The one-side region is placed closer to a winding start side (core side) than the both-side region. In the non-aqueous electrolyte secondary battery, by providing the one-side region closer to the winding start side than the both-side region, energy density at the winding start side is reduced, stress by expansion and contraction following occlusion of lithium is relieved, and local distortion is relieved.

### CITATION LIST

### Patent Literature

Patent Literature 1: JP 2006-24464 A

### SUMMARY

While the non-aqueous electrolyte secondary battery of Patent Literature 1 relieves the local distortion by being provided with the one-side region of the positive electrode active substance layer, the energy density of the non-aqueous electrolyte secondary battery is reduced. That is, it is difficult to suppress local distortion without intentionally reducing the energy density of the non-aqueous electrolyte secondary battery. On the other hand, a local distortion and the like accumulate by repeating charge and discharge of the non-aqueous electrolyte secondary battery, and the electrode body may be buckled.

It is an advantage of the present disclosure to provide a non-aqueous electrolyte secondary battery in which buckling of an electrode body is suppressed.

A non-aqueous electrolyte secondary battery that is one aspect of the present disclosure includes an electrode body in which a positive electrode and a negative electrode are wound with a separator sandwiched between the positive electrode and the negative electrode. The electrode body is housed in a housing member in a cylindrical shape. The positive electrode includes a positive electrode collector and a positive electrode active substance layer. The positive electrode active substance layer is placed to extend on the positive electrode collector. The negative electrode includes a negative electrode collector, a negative electrode active substance layer and a negative electrode lead. The negative electrode active substance layer is placed to extend on the negative electrode collector. The negative electrode lead is connected to the negative electrode collector. The negative electrode lead is disposed closer to a core side of the electrode body than an end portion of the negative electrode active substance layer and an end portion of the positive electrode active substance layer. When the housing member is cut along such a plane that the housing member is in a circular shape, a center of the housing member is set as a vertex of an angle, virtual lines drawn from the vertex of the angle to both ends of the negative electrode lead are set as sides of the angle, and at least one of the end portion of the negative electrode active substance layer and the end portion of the positive electrode active substance layer is included in a region of the acute angle defined by the center of the angle and the sides of the angle.

According to the present disclosure, a non-aqueous electrolyte secondary battery in which occurrence of buckling in the electrode body is suppressed may be provided.

### BRIEF DESCRIPTION OF DRAWINGS

FIG. 1 is a sectional view including an axis center of a non-aqueous electrolyte secondary battery.

FIG. 2 is a perspective view of an electrode body of the non-aqueous electrolyte secondary battery.

FIG. 3 is a front view illustrating a state before winding of a positive electrode and a negative electrode configuring the electrode body.

FIG. 4 is a schematic sectional view of a vicinity of a core of the electrode body at a time of cutting the electrode body along a plane perpendicular to a Z-direction.

FIG. 5 is a schematic sectional view corresponding to FIG. 4 in an electrode body of a reference example.

FIG. 6 is a schematic sectional view corresponding to FIG. 4 in an electrode body of modified example 1.

FIG. 7 is a schematic sectional view corresponding to FIG. 4 in an electrode body of modified example 2.

### DESCRIPTION OF EMBODIMENTS

Hereinafter, an embodiment will be described in detail with reference to the drawings. The present disclosure is not limited to the embodiment, but can be carried out by being properly changed in a range without changing the gist of the present disclosure. Further, the drawings that are referred to in explanation of the embodiment are schematically illustrated.

The embodiment is explained by using words such as an r-direction, a θ-direction, a Z-direction and a γ direction. The r-direction shows a radial direction (radial direction of an electrode body 14) of a non-aqueous electrolyte secondary battery 10 that is a cylindrical battery. The θ-direction shows a circumferential direction (circumferential direction of the electrode body 14) of the non-aqueous electrolyte secondary battery 10. The Z-direction shows a height direction (axial direction) of the non-aqueous electrolyte secondary battery 10, and corresponds to a height direction (axial direction) of the electrode body 14. The γ-direction shows a longitudinal direction (winding direction) at a time of developing a band-shaped positive electrode 11, a band-shaped negative electrode 12 and a band-shaped separator 13 into rectangular shapes.

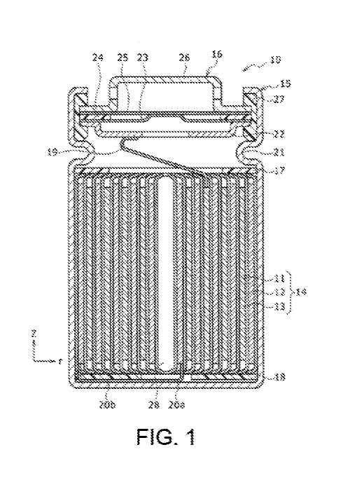

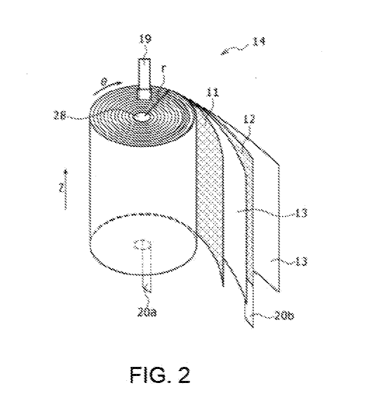

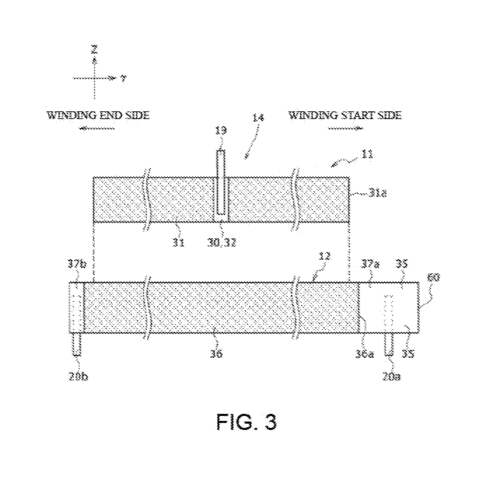

FIG. 1 is a sectional view including an axis center of the non-aqueous electrolyte secondary battery 10. FIG. 2 is a perspective view of the electrode body 14 of the non-aqueous electrolyte secondary battery 10. FIG. 3 is a front view illustrating a state before winding of the positive electrode 11 and the negative electrode 12 that configure the electrode body 14, which is a front view at a time of developing the positive electrode 11 and the negative electrode 12 into rectangular shapes. In FIG. 3, a right side of the sheet is a winding start side of the electrode body 14, and a left side of the sheet is a winding end side of the electrode body 14.

The non-aqueous electrolyte secondary battery 10 is a cylindrical battery having a cylindrical metallic case main body (housing member). The non-aqueous electrolyte secondary battery 10 includes the winding type electrode body 14 and a non-aqueous electrolyte (not illustrated). An insulation plate 17 is provided at an upper part of the electrode body 14, and an insulating plate 18 is provided at a lower part of the electrode body 14. A positive electrode lead 19 extends to a sealing body 16 side by passing through a through-hole of the insulation plate 17, and is welded to an undersurface of a filter 22 that is a bottom plate of the sealing body 16. The filter 22 is electrically connected to a cap 26 that is a top plate of the sealing body 16. The cap 26 is a positive electrode terminal of the non-aqueous electrolyte secondary battery 10. A negative electrode lead 20a passes through a through-hole of the insulating plate 18, and a negative electrode lead 20b passes through an outer side of the insulating plate 18 to extend to a bottom portion side of the case main boy 15 and to be welded to an inner surface of a bottom portion of the case main body 15. The case main body 15 is a negative electrode terminal of the non-aqueous electrolyte secondary battery 10.

The case main body 15 is a bottomed cylindrical metal container. A gasket 27 is provided between the case main body 15 and the sealing body 16, and hermeticity in the battery case is ensured. The case main body 15 has a protruded portion 21 that supports the sealing body 16. The protruded portion 21 is formed by pressing a side surface portion from outside, for example. The protruded portion 21 is preferably formed into an annular shape along the circumferential direction of the case main body 15, and supports the sealing body 16 on a top surface of the protruded portion 21.

The sealing body 16 has the filter 22, a lower valve body 23, an insulating member 24, an upper valve body 25, and a cap 26, which are stacked in order from an electrode body 14 side. The respective members 22 to 26 that configure the sealing body 16 have disk shapes or ring shapes, for example, and the respective members 22, 23, 25 and 26 except for the insulating member 24 are electrically connected to one another. The lower valve body 23 and the upper valve body 25 are electrically connected to each other in a central portion in the r-direction, and the insulating member 24 is interposed in a space in the Z-direction in circumferential edge portions of the lower valve body 23 and the upper valve body 25. When an internal pressure of the battery increases due to abnormal heating, the lower valve body 23 is broken, whereby the upper valve body 25 bulges to a cap 26 side to separate from the lower valve body 23, and electric connection of both of the upper valve body 25 and the lower valve body 23 is cut off. When the internal pressure further increases, the upper valve body 25 is broken, and gas is discharged from an opening portion of the cap 26.

The winding type electrode body 14 has the long positive electrode 11, the long negative electrode 12 and the long separator 13. The positive electrode 11 and the negative electrode 12 are spirally wound with the separator 13 sandwiched between the positive electrode 11 and the negative electrode 12. The non-aqueous electrolyte includes a non-aqueous solvent, and electrolyte salt dissolved in the non-aqueous solvent. The non-aqueous electrolyte is not limited to liquid electrolytes, but may be a solid electrolyte using a gel polymer and the like.

The positive electrode 11 has a band-shaped positive electrode collector 30, and the positive electrode lead 19 joined to the positive electrode collector 30. The positive electrode lead 19 electrically connects the positive electrode collector 30 and a positive electrode terminal. The positive electrode lead 19 is a band-shaped conductor member. The positive electrode lead 19 extends to one side (upper side) in the Z-direction from the positive electrode collector 30. The positive electrode lead 19 is provided in a substantially central portion in the r-direction in the electrode body 14, for example.

The negative electrode 12 has a band-shaped negative electrode collector 35, and the negative electrode leads 20a and 20b which are connected to the negative electrode collector 35. The negative electrode leads 20a and 20b electrically connect the negative electrode collector 35 and a negative electrode terminal. The negative electrode leads 20a and 20b are band-shaped conductor members. The negative electrode leads 20a and 20b extend to the other side (lower side) in the Z-direction from the negative electrode collector 35. As illustrated in FIG. 2, the negative electrode lead 20a is provided at an end portion (end portion at a core side of the electrode body 14) of the negative electrode collector 35 located at a winding start side of the electrode body 14. The negative electrode lead 20b is provided at an end portion (end portion at a winding outer side of the electrode body 14) of the negative electrode collector 35 located at a winding end side of the electrode body 14.

The positive electrode lead 19 and the negative electrode leads 20a and 20b have thicknesses three times to 30 times as large as thicknesses of the collectors 30 and 35, and have thicknesses of 50 μm to 500 μm, for example. The positive electrode lead 19 is preferably configured by a metal with an aluminum as a main component. The negative electrode leads 20a and 20b are preferably configured by metals with nickel or copper as main components. A hardness of the negative electrode lead 20a preferably has a Vickers hardness (Rockwell hardness) in a range of 30 to 100, for example, and more preferably has a Vickers hardness in a range of 60 to 100. When the negative electrode lead 20a is too hard, it becomes difficult to form the electrode body 14 into the cylindrical shape. When the hardness of the negative electrode lead is small, buckling of the electrode body 14 cannot be suppressed as will be described later. When the negative electrode lead has different Vickers hardnesses on a front surface and a back surface, for example, the hardness on the surface having a larger Vickers hardness is preferably included in the aforementioned Vickers hardness. A number, disposition and the like of the positive electrode leads are not specially limited. The negative electrode lead may be provided at only an end portion (end portion at the core side of the electrode body 14) at the winding start side of an inner side in the r-direction of the electrode body 14.

As illustrated in FIG. 2, the positive electrode 11, the negative electrode 12 and the separators 13 are spirally wound in a state where the positive electrode 11, the negative electrode 12 and the separators 13 are alternately stacked in the r-direction. A width direction of the positive electrode 11, the negative electrode 12 and the separator 13 corresponds to the Z-direction. The negative electrode 12 and the negative electrode collector 35 are long. A short direction of the negative electrode 12 and the negative electrode collector 35 is a width direction of the negative electrode 12 and the negative electrode collector 35. In the present embodiment, a space 28 is provided in a core that is a center of the electrode body 14, but a center pin may be placed in the core of the electrode body.

As the separator 13, a porous sheet having ion permeability and an insulating property is used, for example. As a specific example of the porous sheet, a microporous thin film, woven fabric, unwoven fabric and the like are cited. As a material of the separator 13, an olefin resin such as polyethylene and polypropylene is preferable. A thickness of the separator 13 is, for example, 10 μm to 50 μm. The separator 13 tends to be made thinner along with the increase in capacity and output of battery. The separator 13 has a melting point of 130° C. to 180° C., for example.

As illustrated in FIG. 3, a dimension in the γ-direction of the positive electrode 11 is smaller than a dimension in the γ-direction of the negative electrode 12. The positive electrode 11 has the band-shaped positive electrode collector 30 and a positive electrode active substance layer 31 placed on each of both surfaces of the positive electrode collector 30. The negative electrode 12 has the band-shaped negative electrode collector 35 and a negative electrode active substance layer 36 placed on each of both surfaces of the negative electrode collector 35. The positive electrode active substance layer 31 is placed on each of both surfaces that are a front side surface (outer side surface in the r-direction) and a back side surface (inner side surface in the r-direction) of the positive electrode collector 30. The negative electrode active substance layer 36 is placed on each of both surfaces that are a front side surface (outer side surface in the r-direction) and a back side surface (inner side surface in the r-direction) of the negative electrode collector 35.

For the positive electrode collector 30, foil of a metal such as aluminum, a film with the metal disposed on a surface layer and the like are used, for example. A thickness of the positive electrode collector 30 is, for example, 10 μm to 30 μm.

The positive electrode active substance layer 31 preferably contains a positive electrode active substance, a conductive agent, and a binder. The positive electrode 11 (positive electrode plate) can be produced by coating both surfaces of the positive electrode collector 30 with a positive electrode mixture slurry containing, for example, a positive electrode active substance, a conductive agent, a binder and a solvent such as N-Methyl-2-pyrrolidone (NMP), drying the coating film, and rolling the positive electrode collector 30.

As the positive electrode active substance, a lithium-containing transition metal oxide containing a transition metal element such as Co, Mn, and Ni can be illustrated. The lithium-containing transition metal oxide is not specially limited, but preferably contains a composite oxide expressed by a general formula Li₁₊ₓMO₂ (in the formula, −0.2<x≤0.2, M contains at least one kind of Ni, Co, Mn and Al), or a lithium-nickel composite oxide expressed by a general formula Li_{X}Ni_{Y}M_{1-X}O₂ (0<X<1.1, 0.8<Y, M is at least one kind of metal).

As examples of the conductive agent, carbon materials such as carbon black (CB), acetylene black (AB), Ketjen black, and graphite and the like are cited. Further, as examples of the binder, fluorine resins such as polytetrafluoroethylene (PTFE) and polyvinylidene fluoride (PVdF), polyacrylonitrile (PAN), polyimide (PI), an acrylic resin, a polyolefin resin, and the like are cited.

The positive electrode 11 has a plain portion 32 where the positive electrode active substance layer 31 is not provided, in a substantially central portion in the γ-direction. In the plain portion 32, the positive electrode collector 30 is exposed. The plain portion 32 is provided throughout an entire length in the Z-direction of the positive electrode collector 30. The plain portion 32 is configured to be wider than the positive electrode lead 19 in the γ-direction. The positive electrode lead 19 is joined to the plain portion 32 by welding or the like. The positive electrode lead 19 is electrically connected to the positive electrode collector 30. From the viewpoint of collection performance, as illustrated in FIG. 3, the plain portion 32 is preferably provided in a position substantially equidistant from both ends of the positive electrode collector 30 in the γ-direction. However, the plain portion may be placed in a vicinity of an end portion of the positive electrode collector 30 in the γ-direction. The plain portion 32 is provided by intermittent coating without coating a part of the positive electrode collector 30 with the positive electrode mixture slurry, for example.

For the negative electrode collector 35, foil of a metal such as a copper, a film in which the metal is disposed on a surface layer, or the like is used, for example. A thickness of the negative electrode collector 35 is, for example, 5 μm to 30 μm. The negative electrode active substance layer 36 preferably contains a negative electrode active substance and a binder. The negative electrode 12 is configured by coating both surfaces of the negative electrode collector 35 with, for example, a negative electrode mixture slurry containing, for example, a negative electrode active substance, a binder, water and the like, drying the coating film, and rolling the negative electrode collector 35.

The negative electrode active substance is not specially limited as long as the substance can reversibly occlude and release lithium ions, and a carbon material such as natural graphite and artificial graphite, Si, a metal alloying with lithium such as Sn, or an alloy containing these substances, composite oxides and the like can be used, for example. For the binder contained in the negative electrode active substance layer 36, a resin similar to the case of the positive electrode 11 is used, for example. When the negative electrode mixture slurry is prepared with an aqueous solvent, styrene-butadiene rubber (SBR), CMC or salt of CMC, polyacrylic acid or salt of polyacrylic acid, polyvinyl alcohol and the like can be used. One kind of these substances may be independently used, or two kinds or more of these substances may be used in combination. The negative electrode active substance is preferably configured by a compound having a layer structure capable of insertion and desorption of Li, for example, the aforementioned natural graphite, artificial graphite or the like.

The negative electrode active substance layer 36 is disposed in a position that is spaced in an extending direction (γ-direction) of the negative electrode collector 35 with respect to an end 60 at the winding start side of the negative electrode collector 35, and on the negative electrode collector 35. The negative electrode active substance layer 36 extends in the γ-direction. In other words, the negative electrode 12 has a plain portion 37a in which the negative electrode active substance layer 36 is not provided, in an end portion of the negative electrode collector 35 at the winding start side of the electrode body 14. The plain portion 37a is located closer to the winding start side of the electrode body 14 than an end portion 36a. The negative electrode 12 also has a plain portion 37b in which the negative electrode active substance layer 36 is not provided on the negative electrode collector 35, in an end portion at a winding end side of the electrode body 14. In the respective plain portions 37a and 37b, the negative electrode collector 35 is exposed.

The plain portion 37a is provided throughout the entire length in the Z-direction of the negative electrode collector 35, and is configured to be wider than the negative electrode lead 20a in the γ-direction. Further, the plain portion 37b is provided throughout the entire length in the Z-direction of the negative electrode collector 35, and is configured to be wider than the negative electrode lead 20b in the γ-direction.

In the example illustrated in FIG. 3, a dimension in the γ-direction of the plain portion 37a at the winding start side of the electrode body 14 is larger than a dimension in the γ-direction of the plain portion 37b at the winding end side of the electrode body 14, but the dimension in the γ-direction of the plain portion 37a is not limited to this. Further, from the viewpoint of collection performance, the plain portions 37a and 37b are preferably provided at both sides in the γ-direction on the negative electrode collector 35. However, a plurality of plain portions may be provided in a vicinity of the central portion in the γ-direction on the negative electrode collector 35. The respective plain portions may be formed with a length that does not reach one end (upper end) in the Z-direction from the other end (lower end) in the Z-direction of the negative electrode. The respective plain portions 37a and 37b are provided by intermittent coating in which a part of the negative electrode collector 35 is not coated with the negative electrode mixture slurry, for example.

The negative electrode lead 20a is directly attached to the plain portion 37a by welding or the like. The negative electrode lead 20a is electrically connected to the negative electrode collector 35. Further, the negative electrode lead 20b is attached to the plain portion 37b by welding or the like. The negative electrode collector 35 and the negative electrode lead 20b are electrically connected. The plain portion 37a is preferably provided on both surfaces of the negative electrode collector 35. The plain portion 37b is preferably provided on both surfaces of the negative electrode collector 35.

The negative electrode lead 20a is joined to a surface at an outer circumferential side in the r-direction of the negative electrode collector 35. The negative electrode lead 20a extends downward from a lower end in the Z-direction of the plain portion 37a. The negative electrode lead 20a is provided at an upper end side from the central portion in the Z-direction of the negative electrode collector 35, and is provided to protrude from the lower end of the negative electrode collector 35.

In the Z-direction (width direction of the negative electrode collector), a length in which the negative electrode lead 20a is superimposed on the negative electrode collector 35 is preferably 70% or more of a length of the negative electrode collector 35, and further preferably is 75% or more. The negative electrode lead may include a portion that is placed from one end (upper end) in the Z-direction of the negative electrode collector to the other end (lower end) in the Z-direction.

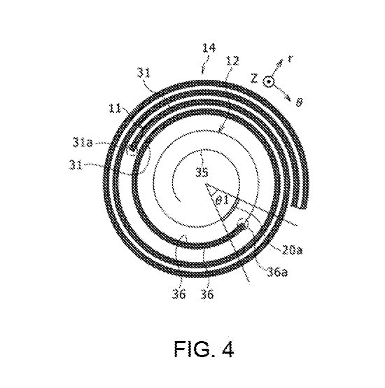

With reference to FIGS. 4 to 7, a structure in the vicinity of the core of the electrode body will be described. FIGS. 4 to 7 are schematic sectional views of the vicinity of the core of the electrode body at a time of the electrode body being cut along a plane perpendicular to the Z-direction. In FIGS. 4 to 7, illustration of the separator 13 is omitted. In FIGS. 4 to 7, θ1, θ2, θ3 and θ4 each shows a region of an acute angle defined by a center of the angle and sides of the angle, with a center of the housing member as a vertex of the angle, and virtual lines drawn from the vertex of the angle to both ends of the negative electrode lead as the sides of the angle, when the housing member is cut along such a plane that the housing member is in a circular shape. “When the housing member is cut along such a plane that the housing member is in a circular shape” can be translated into “when the electrode body is cut along the plane perpendicular to the Z-direction”.

When the non-aqueous electrolyte secondary battery 10 is charged and discharged, the positive electrode active substance layer 31 and the negative electrode active substance layer 36 expand and contract with occlusion of lithium ions. When charge and discharge of the non-aqueous electrolyte secondary battery 10 are repeated, buckling in which the electrode body 14 locally bends toward the core of the electrode body may occur to the electrode body 14.

The present inventor found that the above buckling occurs partly because of stress concentration that occurs to the end portion 31a of the positive electrode active substance layer 31 and/or the end portion 36a of the negative electrode active substance layer 36. Inside the winding structure of the electrode body, the end portion 31a and the end portion 36a are steps due to thicknesses of the positive electrode active substance layer 31 and the negative electrode active substance layer 36, and configure corner portions. Stress accompanying expansion and contraction of the positive electrode active substance layer 31 and the negative electrode active substance layer 36 concentrates on the end portion 31a and/or the end portion 36a, and buckling easily occurs around the end portion 31a and/or the end portion 36a.

FIG. 4 is a schematic view showing a configuration of the electrode body 14 for suppressing occurrence of buckling. As illustrated in FIG. 4, the end portion 36a at the winding start side of the electrode body 14 in the negative electrode active substance layer 36 is placed at an outer circumferential side from the negative electrode lead 20a at the core side in the r-direction (radial direction of the electrode body 14). The end portion 36a is provided in the region (range of the center angle) θ1 where the negative electrode lead 20a exists in a θ-direction (circumferential direction of the electrode body 14). The end portion 36a of the negative electrode active substance layer 36 is preferably placed in a center of the region θ1. The end portion 36a of the negative electrode active substance layer may be placed in a place other than the center of the region θ1 where the negative electrode lead 20a at the core side exists.

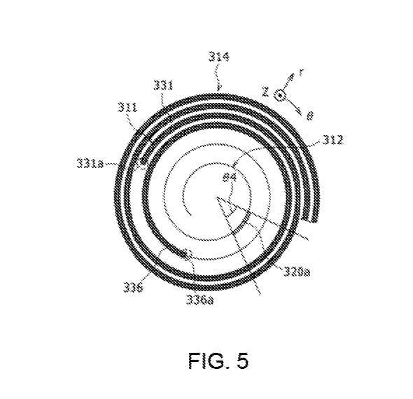

FIG. 5 is a schematic sectional view corresponding to FIG. 4 in an electrode body 314. In the electrode body 314, both of an end portion 331a of a positive electrode active substance layer 331 in a positive electrode 311, and an end portion 336a of a negative electrode active substance layer 336 in a negative electrode 312 are disposed outside a range of a region θ4 in the θ-direction where a negative electrode lead 320a at a core side is provided. Therefore, there exists no means that can suppress stress concentration that occurs to the end portion 331a of the positive electrode active substance layer 331 and the end portion 336a of the negative electrode active substance layer 336, so that buckling easily occurs around the end portions 331a and 336a.

According to the electrode body 14 illustrated in FIG. 4, the end portion 36a of the negative electrode active substance layer 36 is placed at the outer circumferential side from the negative electrode lead 20a in the radial direction (r-direction) of the electrode body 14, and in the range of the region θ1 where the negative electrode lead 20a exists in the circumferential direction (θ-direction) of the electrode body 14. Accordingly, at least a part of the end portion 36a overlaps the negative electrode lead 20a having large rigidity when seen from the r-direction. The negative electrode lead 20a with large rigidity can suppress deformation in the r-direction (the core direction of the electrode body 14) of the end portion 36a, and can suppress buckling of the electrode body 14 with the end portion 36a being a starting point.

Note that the present disclosure is not limited to the above described embodiment and modified examples thereof, but various improvements and changes can be made within the range of the matters described in the claims of the present application and equivalents of the matters.

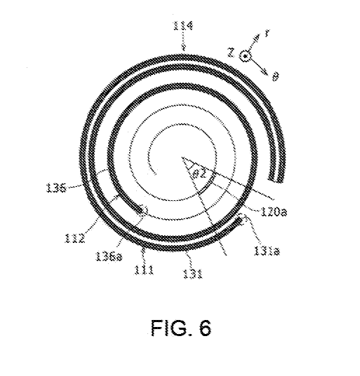

FIG. 6 is a schematic sectional view corresponding to FIG. 4 in an electrode body 114 in modified example 1. In modified example 1, instead of the end portion 36a of the negative electrode active substance layer 36, an end portion 131a of a positive electrode active substance layer 131 is placed at an outer circumferential side from a negative electrode lead 120a in a radial direction (r-direction) of the electrode body 114, and in a range of a region (range of a center angle) θ2 where a negative electrode lead 120a exists in a circumferential direction (θ-direction) of the electrode body 114.

At least a part of the end portion 131a of the positive electrode active substance layer 131 overlaps the negative electrode lead 120a with large rigidity when seen from the r-direction. The negative electrode lead 120a with large rigidity can suppress deformation in the r-direction (core direction of the electrode body 114) of the end portion 131a, and can suppress buckling of the electrode body 114 with an end portion 136a being a starting point. In a case of modified example 1, the end portion 131a also becomes difficult to deform in the r-direction, and buckling with the end portion 131a as the starting point can be also suppressed. Note that in modified example 1, the end portion 131a of the positive electrode active substance layer 131 is also preferably placed in a vicinity of a center of the region θ2, as illustrated in FIG. 6. However, the end portion of the positive electrode active substance layer may be placed in a place other than the center of the region θ2.

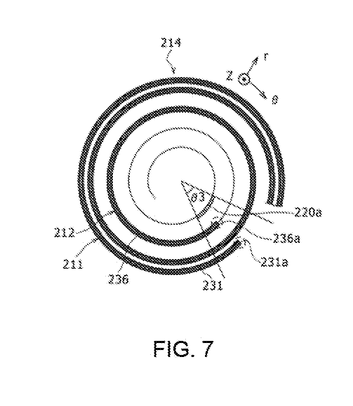

FIG. 7 is a schematic sectional view corresponding to FIG. 4 in an electrode body 214 of modified example 2. In modified example 2, an end portion 231a of a positive electrode active substance layer 231 and an end portion 236a of a negative electrode active substance layer 236 are placed at an outer circumferential side from a negative electrode lead 220a in a radial direction (r-direction) of the electrode body 214, and in a region (range of a center angle) θ3 where the negative electrode lead 220a exists in a circumferential direction (θ-direction) of the electrode body 214. In a case of modified example 2, the end portions 231a and 236a become difficult to deform in the r-direction, and buckling of the electrode body 214 with the end portions 231a and 236a becoming starting points can be suppressed.

In a case of modified example 2, the end portion 231a of the positive electrode active substance layer 231 and the end portion 236a of the negative electrode active substance layer 236 may be placed in different phases from each other in the range of the region θ3. Further, at least one of the two end portions is preferably placed in a vicinity of a center of the region where the negative electrode lead at the core side exists, but is not limited to this.

Note that the region where the negative electrode active substance layer is provided is larger than the region where the positive electrode active substance layer is provided, so that a force due to expansion and contraction following occlusion of lithium tends to be larger in the negative electrode than in the positive electrode. Therefore, the end portion of the negative electrode active substance layer is preferably placed at the outer circumferential side from the negative electrode lead in the radial direction (r-direction) of the electrode body, and in the region where the negative electrode lead exists in the circumferential direction (θ-direction) of the electrode body.

Further, the negative electrode lead may include an upper end to a lower end in a width direction (Z-direction) of the band-shaped negative electrode collector. A whole of at least one of the end portion of the positive electrode active substance layer and the end portion of the negative electrode active substance layer may overlap the negative electrode lead when seen from the radial direction (r-direction) of the electrode body. In this case, it is preferable because the whole of at least one end portion be supported in the r-direction by the negative electrode lead.

Further, if the hardness of the negative electrode lead is made Vickers hardness in a range of 30 to 100, deformation of surroundings of the end portion of the positive electrode active substance layer and/or the end portion of the negative electrode active substance layer can be effectively suppressed. Further, setting a film thickness of the negative electrode lead in a range of 50 μm to 500 μm is preferable because deformation of the surroundings of the end portions can be effectively suppressed.

### INDUSTRIAL APPLICABILITY

The present invention can be applied to a non-aqueous electrolyte secondary battery.

### REFERENCE SIGNS LIST

10 Non-aqueous electrolyte secondary battery
11 Positive electrode
12 Negative electrode
13 Separator
14, 114, 214 Electrode body
19 Positive electrode lead
20a, 120a, 220a Negative electrode lead
30 Positive electrode collector
31, 131, 231 Positive electrode active substance layer
31a, 131a, 231a end portion of positive electrode active substance layer
32 Plain portion
35 Negative electrode collector
36, 136, 236 Negative electrode active substance layer
36a, 136a, 236a End portion of negative electrode active substance layer
37a, 37b Plain portion
θ1 Acute angle

1. A non-aqueous electrolyte secondary battery including an electrode body in which a positive electrode and a negative electrode are wound with a separator sandwiched between the positive electrode and the negative electrode,
wherein the electrode body is housed in a housing member in a cylindrical shape,
the positive electrode includes a positive electrode collector and a positive electrode active substance layer,
the positive electrode active substance layer is placed to extend on the positive electrode collector,
the negative electrode includes a negative electrode collector, a negative electrode active substance layer and a negative electrode lead,
the negative electrode active substance layer is placed to extend on the negative electrode collector,
the negative electrode lead is connected to the negative electrode collector,
the negative electrode lead is disposed closer to a core side of the electrode body than an end portion of the negative electrode active substance layer located at a winding start side of the electrode body and an end portion of the positive electrode active substance layer located at the winding start side of the electrode body,
when the housing member is cut along such a plane that the housing member is in a circular shape, a center of the housing member is set as a vertex of an angle, and virtual lines which are drawn toward both ends of the negative electrode lead from the vertex of the angle are set as sides of the angle, and
at least one of the end portion of the negative electrode active substance layer and the end portion of the positive electrode active substance layer is included in a region of an acute angle defined by a center of the angle and the sides of the angle.

2. The non-aqueous electrolyte secondary battery according to claim 1,
wherein the negative electrode collector is long, and when a short direction of the negative electrode collector is set as a width direction of the negative electrode collector,
the negative electrode lead in a width direction of the negative electrode collector has a length of 70% or more of a length of the negative electrode collector in the width direction of the negative electrode collector.

3. The non-aqueous electrolyte secondary battery according to claim 1,
wherein a whole of at least one of the end portion of the negative electrode active substance layer and the end portion of the positive electrode active substance layer overlaps the negative electrode lead, when seen from a radial direction of the electrode body.

4. The non-aqueous electrolyte secondary battery according to claim 1,
wherein the positive electrode active substance layer contains a lithium-nickel composite oxide represented by a general formula Li_{X}Ni_{Y}M₁₋ₓO₂ (0<X<1.1, 0.8<Y, M comprises at least one kind or more of metal).

5. The non-aqueous electrolyte secondary battery according to claim 1,
wherein the negative electrode active substance is a compound having a layer structure capable of insertion and desorption Li.

6. The non-aqueous electrolyte secondary battery according to claim 1,
wherein the negative electrode lead has a thickness of three times to thirty five times inclusive as large as a thickness of the positive electrode collector and the negative electrode collector.

7. The non-aqueous electrolyte secondary battery according to claim 1,
wherein the negative electrode lead has a hardness included in a Vickers hardness in a range of 30 to 100.
